(19) United States
(12) Patent Application Publication
(10) Pub. No.: US 2009/0194384 A1
(43) Pub. Date: Aug. 6, 2009

(54) WET MULTI-PLATE CLUTCH

(75) Inventors: Hitoshi TSUKUDA, Wako-shi (JP); Hiroki KAWANA, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 12/361,860

(22) Filed: Jan. 29, 2009

(30) Foreign Application Priority Data
Feb. 4, 2008 (JP) 2008-023706

(51) Int. Cl. F16D 11/00

(52) U.S. Cl. 192/107 C

(57) ABSTRACT

A wet multi-plate clutch supplies lubricating oil via a lubricating gallery from an inner circumferential surface of a cylindrical member of a clutch hub to a plurality of plates. The lubricating oil is appropriately supplied to a space between adjacent plates even under an idle neutral control. In the wet multi-plate clutch, a cylindrical member is divided into a plurality of areas having identical length in the circumferential direction, each area is provided with a group of lubricating gallery set consisting of a plurality of lubricating galleries formed at mutually different positions in the axial direction by shifting the positions of the plurality of lubricating galleries which constitute the group of lubricating gallery set in the circumferential direction. An open end portion of the cylindrical member is provided with a circular dam portion protruding inward in a radial direction, an inner radius of the dam portion is configured to be not greater than a radius of a concentric circle which is concentric with the cylindrical member and is tangent to a line joining two ends of each area of the cylindrical member in the circumferential direction.

### BACKGROUND OF THE INVENTION

1. Field of the Invention

The present invention relates to a wet multi-plate clutch used in an automatic transmission of a vehicle or the like.

2. Description of the Related Art

Conventionally, there has been known a wet multi-plate clutch which includes a shaft; a clutch drum which is fixed to the shaft; a plurality of outer plates which are slidably splined to an inner circumferential surface of the clutch drum along the axial direction of the shaft; a clutch hub which has a cylindrical member located in the clutch drum and is disposed at the same axis line as the shaft; and a plurality of inner plates which are slidably splined to an outer circumferential surface of the cylindrical member of the clutch hub, in which the cylindrical member is divided into a plurality of areas having identical length in the circumferential direction, each area is provided with a group of lubricating gallery set consisting of a plurality of lubricating galleries formed at mutually different positions in the axial direction by shifting the positions of the plurality of lubricating galleries which constitute the group of lubricating gallery set in the circumferential direction, and lubricating oil is supplied to the cylindrical member by flowing from the inner circumferential surface to the outer circumferential surface via the plurality of lubricating galleries (for example, refer to Japanese Patent Laid-open No. H5-231446, which is referred to as Patent Document 1 hereinafter).

In the wet multi-plate clutch disclosed in Patent Document 1, the cylindrical member is divided into a plurality of areas having identical length in the circumferential direction, each area is provided with a group of lubricating gallery set consisting of a plurality of lubricating galleries formed at mutually different positions in the axial direction by shifting the positions of the plurality of lubricating galleries which constitute the group of lubricating gallery set in the circumferential direction. According thereto, the lubricating oil is prevented from flowing out completely from the other lubricating galleries before supplied from the lubricating galleries located at an open end portion. Thereby, the lubricating oil is supplied to a space between adjacent plates from all of the lubricating galleries appropriately.

Further, the open end portion of the cylindrical member of the clutch hub is provided with a circular dam portion protruding inward in a radial direction. The lubricating oil is prevented from scattering out of the open end portion of the cylindrical member by the dam portion. The protruded height of the dam portion is configured to be relatively low in provision that it can sufficiently prevent the lubricating oil from scattering out of the open end portion of the cylindrical member when the clutch hub is rotating.

In recent years, an idle neutral control has been practically applied to an automatic transmission which joins input shafts to an engine through a fluid torque converter (for example, refer to Japanese Patent laid-open No. 3680641). When a vehicle is halted at a state where a shift position of the automatic transmission is set in a driving range, the engaging force of a 1-speed clutch is weakened so that the 1-speed clutch is half engaged. Such state which is approximate to a neutral state is referred to as the idle neutral control. According to the idle neutral control, the load on the fluid torque converter is alleviated to reduce the driving torque of the engine, thereby improving the mileage of the vehicle.

During the idle neutral control, since a driving wheel is halted, the clutch hub for the 1-speed clutch which is interlocked with an output shaft of the automatic transmission through a train of 1-speed gears stands still without rotation. In this situation, the lubricating oil is accumulated in the lowest part on the inner circumferential surface of the cylindrical member of the clutch hub, and the accumulated lubricating oil is supplied from the lowest part on the inner circumferential surface of the cylindrical member via the lubricating galleries to a space between the outer plate and the inner plate which rotate relatively.

However, according to the conventional wet multi-plate clutch, since the height of the dam portion protruded is low, only a part of the group of lubricating gallery set is in communication with the lubricating oil accumulated in the lowest part on the inner circumferential surface of the cylindrical member. Therefore, a plate corresponding to a lubricating gallery which is not in communication with the accumulated lubricating oil will not be supplied with lubricating oil, resulted in problems of aggravating heat generation and abrasion in the 1-speed clutch.

### SUMMARY OF THE INVENTION

The present invention has been accomplished in view of the aforementioned problems, and it is therefore an objective of the present invention to provide a wet multi-plate clutch which can appropriately supply lubricating oil to a space between adjacent plates even under an.

To attain/accomplish the objectives described above, there is provided a wet multi-plate clutch including: a clutch drum which is fixed to a shaft; a plurality of outer plates which are slidably splined to an inner circumferential surface of the clutch drum along the axial direction of the shaft; a clutch hub which has a cylindrical member located in the clutch drum and is disposed at the same axis line as the shaft; and a plurality of inner plates which are slidably splined to an outer circumferential surface of the cylindrical member of the clutch hub, in which the cylindrical member is divided into a plurality of areas having identical length in the circumferential direction thereof, each of the areas is provided with a group of lubricating gallery set consisting of a plurality of lubricating galleries formed at mutually different positions in the axial direction with the positions of the plurality of lubricating galleries which constitute the group of lubricating gallery set shifted in the circumferential direction, and lubricating oil is supplied to the cylindrical member by flowing from the inner circumferential surface to the outer circumferential surface via the plurality of lubricating galleries, wherein an open end portion of the cylindrical member is provided with a circular dam portion protruding inward in a radial direction, an inner radius of the dam portion is configured to be not greater than a radius of a concentric circle which is concentric with the cylindrical member and is tangent to a line joining two ends of each of the areas on the inner circumferential surface of the cylindrical member in the circumferential direction.

By providing the dam portion as described above, when the clutch hub is halted, the lubricating oil will be accumulated in the lowest part on the inner circumferential surface of the cylindrical member with the same height as the inner radius of the dam portion. Further, by configuring the inner radius of the dam portion as described above, the perimeter of the cylindrical member positioned below the liquid surface of the lubricating oil accumulated in the lowest part on the inner circumferential surface of the cylindrical member at least equals to the perimeter of one of the above-mentioned area where one group of lubricating gallery set is provided, therefore, the lubricating oil accumulated in the lowest part on the inner circumferential surface of the cylindrical member flows down to the outer circumferential surface of the cylindrical member through at least all the lubricating galleries constituting one set of the lubricating galleries. Accordingly, even when the clutch hub is halted, the lubricating oil is preferably supplied to all the spaces between adjacent outer and inner plates, thereby inhibiting the heat generation and abrasion of each plate under idle neutral control.

### BRIEF DESCRIPTION OF THE DRAWINGS

FIG. 1 is a skeleton diagram illustrating an automatic transmission applied with a wet multi-plate clutch according to an embodiment of the present invention;

FIG. 2 is a sectional view illustrating a lower part of the wet multi-plate clutch according an embodiment of the present invention;

FIG. 3 is a perspective view illustrating a clutch hub of the wet multi-plate clutch according to an embodiment of the present invention; and

FIG. 4 is a sectional view illustrating the clutch hub cut away along the IV-IV line in FIG. 2.

### DETAILED DESCRIPTION OF THE PREFERRED EMBODIMENTS

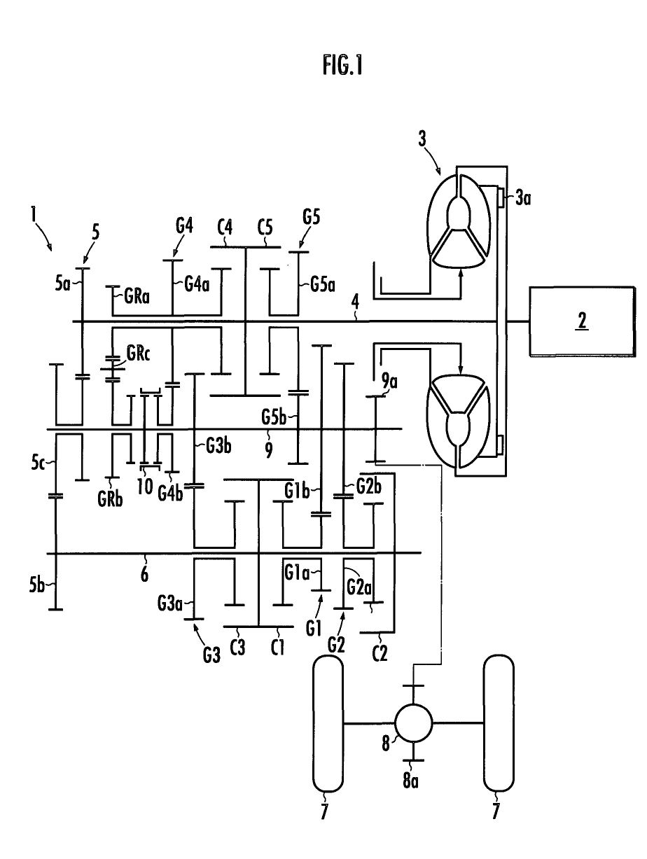

As illustrated in FIG. 1, reference numeral 1 denotes an automatic transmission used in a vehicle for performing 5-speed forward and 1-speed reverse speed alteration. The automatic transmission 1 is a 3 parallel axis-typed one, including a first input shaft 4, a second shaft 6, and an output shaft 9, which are disposed parallel to each other.

The first input shaft 4 is interlocked with an engine 2 through a fluid torque converter 3 having a lockup clutch 3a. The second input shaft 6 is interlocked with the first input shaft 4 through a train of gears 5 so as to rotate synchronously with the first input shaft 4. The output shaft 9 has an output gear 9a at the end thereof intermeshing with a final gear 8a at a differential gear 8 which is interlocked with a pair of driving wheels 7. It should be noted that the final gear 8a and the output gear 9a are drawn separated in FIG. 1; in fact, they are intermeshing with each other.

The train of gears 5 is comprised of a gear 5a at an end of the first input shaft 4, a gear 5b at an end of the second input shaft 6, and an idler 5c intermeshing with both of the gears 5a and 5b.

Between the first input shaft 4 and the output shaft 9, there are disposed in parallel a train of 5-speed gears G5, a train of 4-speed gears G4, and a train of reverse gears GR. Between the second input shaft 6 and the output shaft 9, there are disposed in parallel a train of 2-speed gears G2, a train of 1-speed gears G3, and a train of 3-speed gears G3.

The train of 1-speed gears G1 is comprised of a driving gear G1a which is interlocked with the second input shaft 6 through a 1-speed clutch C1, and a driven gear G1b which intermeshes with the driving gear G1a and is interlocked with the output shaft 9.

Similarly, the train of 2-speed gears G2 is comprised of a driving gear G2a which is interlocked with the second input shaft 6 through a 2-speed clutch C2, and a driven gear G2b which intermeshes with the driving gear G2a and is interlocked with the output shaft 9, and the train of 3-speed gears G3 is comprised of a driving gear G3a which is interlocked with the second input shaft 6 through a 3-speed clutch C3, and a driven gear G3b which intermeshes with the driving gear G3a and is interlocked with the output shaft 9.

The train of 5-speed gears G5 is comprised of a driving gear G5a which is interlocked with the first input shaft 4 through a 5-speed clutch C5, and a driven gear G5b which intermeshes with the driving gear G5a and is interlocked with the output shaft

The train of 4-speed gears G4 is comprised of a driving gear G4a which is interlocked with the first input shaft 4 through a 4-speed clutch C4, and a driven gear G4b which intermeshes with the driving gear G4a and is pivotally supported by the output shaft 9.

The train of reverse gears GR is comprised of a driving gear GRa which is jointed to the 4-speed gear G4a, and a driven gear GRb which intermeshes with the driving gear GRa through an idle gear GRc and is pivotally supported by the output shaft 6.

The 4-speed driven gear G4a and the reverse driven gear GRb are selectively interlocked with the output shaft 6 via a selector 10 for switching the forward and the reverse operations.

According to the above-mentioned configuration, when the 1-speed clutch C1 is engaged, the 1-speed position is established. Similarly, when the 2-speed clutch C2 is engaged, the 2-speed position is established; when the 3-speed clutch C3 is engaged, the 3-speed position is established; when the 4-speed clutch C4 is engaged in a condition that the 4-speed driven gear G4b is interlocked with the output shaft 6 by the selector 10, the 4-speed position is established; when the 5-speed clutch C5 is engaged, the 5-speed position is established; and when the 4-speed clutch C4 is engaged in a condition that the reverse driven gear GRb is interlocked with the output shaft 6 by the selector 10, the reverse position is established.

The automatic transmission 1 is controlled by a transmission control unit (TCU) which is not shown in the drawings. The TCU performs an idle neutral control in which the 1-speed position is selected and the 1-speed clutch C1 is half engaged in a condition that the shift is positioned in the D range (forward rang) and the vehicle is halted.

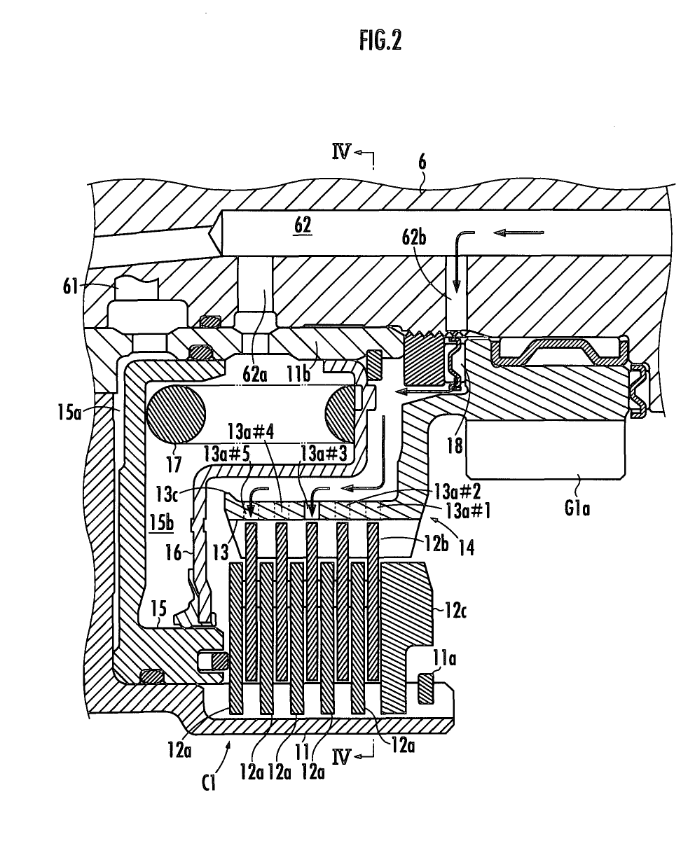

The 1-speed clutch C1 in the automatic transmission 1 with the above-mentioned configuration corresponds to a wet multi-plate clutch of an embodiment of the present invention. Detailed description thereof will be given with reference to FIG. 2 through FIG. 4.

The 1-speed clutch C1 is comprised of a clutch drum 11, a plurality of outer plates 12a, a clutch hub 14, and a plurality of inner plates 12b.

The clutch drum 11 possesses a shape of a cylinder with a bottom, and is fixed at the second input shaft 6.

The plurality of outer plates 12a are slidably splined to an inner circumferential surface of the clutch drum 11 along the axial direction of the second input shaft 6. The clutch hub 14 has a cylindrical member 13 positioned inside the clutch drum 11 and is rotatably and pivotally supported by the second input shaft 6. The plurality of inner plates 12b are slidably splined to an outer circumferential surface of the cylindrical member 13 of the clutch hub 14 along the axial direction of the second input shaft 6. The 1-speed driving gear G1a is integrally provided in the clutch hub 14.

An open end portion of the inner circumferential surface of the clutch drum 11 is provided with a circlip 11a to prevent the plates 12a and 12b from dropping out of the open end portion through a clipping plate 12c. The clutch drum 11 is provided therein with a piston 15 which presses the plates 12a and 12b to slide freely in the axial direction. Between the clutch drum 11 and the piston 15, there is defined an oil pressure chamber 15a. Operating oil is supplied to the oil pressure chamber 15a from an oil passage 61 disposed in the second input shaft 6, pressing the piston 15 to slide in the clutch drum 11 to sandwich the plates 12a and 12b with the clipping plate 12c, as a result thereof, enabling the 1-speed clutch C1 to an engaged state.

The clutch drum 11 is disposed therein with a retainer 16 to define an oil pressure cancelling chamber 15b together with the piston 15. A return spring 17 for biasing the piston 15 is disposed in the oil pressure cancelling chamber 15b. The oil pressure cancelling chamber 15b is supplied with lubricating oil from a lubricating oil supply passage 62 disposed in the second input shaft 6 through an oil gallery 62a. Accordingly, the oil pressure in the oil pressure chamber 15a increases due to centrifugal force in a high-speed rotation, while when the speed is altered, the clutch release will be delayed. This can be avoided by the oil pressure from the oil pressure cancelling chamber 15b.

A oil gallery 62b is formed in the second input shaft 6, facing a thrust bearing 18 inserted between a fitting member 11b for fitting the clutch drum 11 at the second input shaft 6. Accordingly, the lubricating oil is supplied to cylindrical member 13 of the clutch hub 14 from the lubrication oil supply passage 62 through the oil gallery 62b and the thrust bearing 18. The lubricating oil supplied to the cylindrical member 13 flows from the inner circumferential surface of the cylindrical member 13 to the outer circumferential surface thereof through a lubricating gallery 13a formed in the cylindrical member 13 to lubricate the space between the plates 12a and 12b.

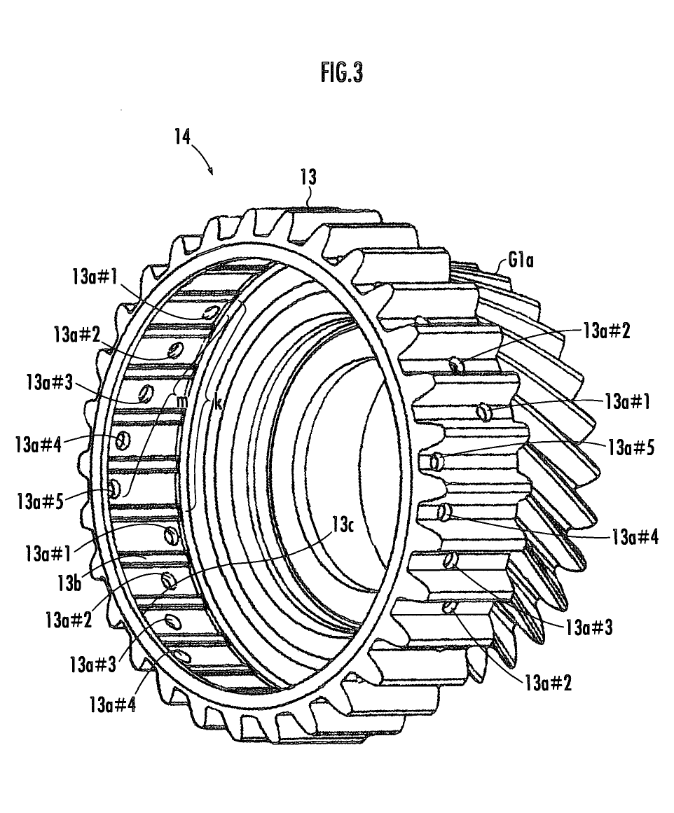

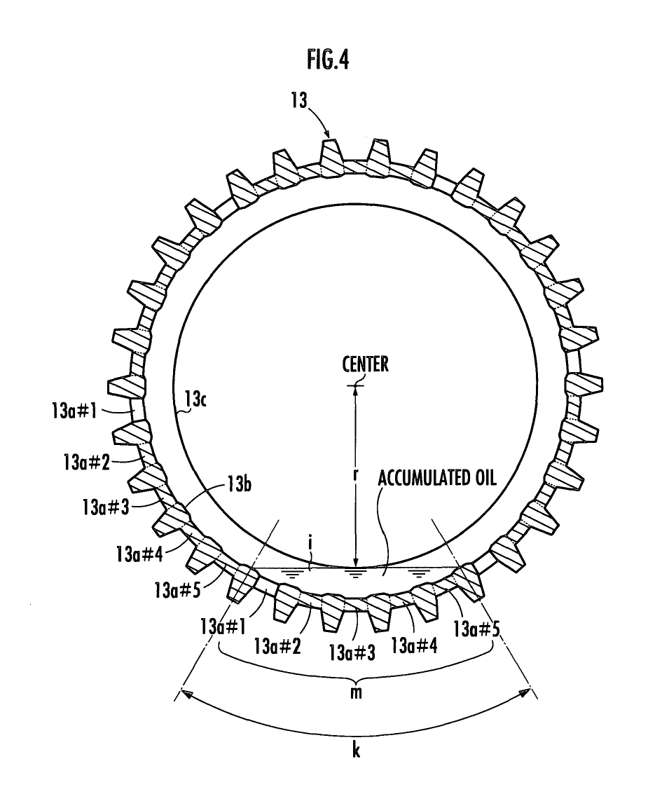

With reference to FIG. 3 and FIG. 4, the cylindrical 13 is divided into a plurality of areas k (six in the present embodiment) having identical length in the circumferential direction. In each area k, a plurality of lubricating galleries 13a from #1 to #5 (five in the present embodiment) are disposed at positions different to each other in the axial direction. The plurality of lubricating galleries 13a from #1 to #5 constitutes a group of lubricating gallery set m. In each area k, the lubricating galleries 13a from #1 to #5 constituting the group of lubricating set m are formed by shifting the positions thereof in the circumferential direction. Moreover, the inner circumferential surface of the cylindrical member 13 is provided with a protruding strip 13b. The protruding strip 13b is positioned between adjacent lubricating galleries 13a and extends in the axial direction. According thereto, when the clutch hub 14 rotates, the lubricating oil is guided by the protruding strip 13b to be supplied to all the lubricating galleries 13a absolutely.

An open end portion of the cylindrical member 13 is provided with a circular dam portion 13c protruding inward in the radial direction thereof. The inner radius of the dam portion 13c is defined to be not more than a radius r of a concentric circle which is concentric with the cylindrical member 13 and is tangent to a line i (refer to FIG. 4) joining two ends of each area k on the inner circumferential surface of the cylindrical member 13 in the circumferential direction. In the present embodiment, the inner radius of the dam portion is the same as the radius r.

By disposing the dam portion 13c as mentioned above, when the clutch hub 14 is halted under the idle neutral control by TCU, the lubricating oil is accumulated in the lowest part on the inner circumferential surface of the cylindrical member 13 with the same height as the inner radius of the dam portion 13c. Since the inner radius of the dam portion 13c is defined as in the above description, the perimeter of the cylindrical member 13 positioned below the liquid surface of the lubricating oil accumulated in the lowest part on the inner circumferential surface of the cylindrical member 13 at least equals to the perimeter of one of the above-mentioned area k where all the lubricating galleries 13a from #1 to #5 constituting the group of lubricating gallery set m is provided at positions different to each other in the axial direction, therefore, the lubricating oil accumulated in the lowest part on the inner circumferential surface of the cylindrical member 13 flows down to the outer circumferential surface of the cylindrical member 13 through the entire lubricating galleries 13a from #1 to #5. Accordingly, even when the clutch hub is halted, the lubricating oil is preferably supplied to all the spaces between adjacent outer plate 12a and inner plate 12b, thereby inhibiting the heat generation and abrasion of each of the plates 12a and 12b under idle neutral control.

It should be noted that the wet multi-plate clutch according to the present invention is described as using as a 1-speed clutch in a 3 parallel axis-typed transmission in the embodiment, but is not limited thereto. For example, in a automatic transmission 1 having a planetary gear, the wet multi-plate clutch can be used as a clutch in the case where a clutch drum with the clutch which is engaged in a 1-speed phase is fixed at an input shaft, and a clutch hub is fixed at a shaft of a son gear of the planetary gear disposed concentrically with the input shaft.

Although the present invention has been explained in relation to the preferred embodiments and drawings but not limited, it should be noted that other possible modifications and variations made without departing from the gist and scope of the invention will be comprised in the present invention. Therefore, the appended claims encompass all such changes and modifications as falling within the gist and scope of the present invention.

What is claimed is:

1. A wet multi-plate clutch, comprising:
a clutch drum which is fixed to a shaft;
a plurality of outer plates which are slidably splined to an inner circumferential surface of the clutch drum along the axial direction of the shaft;
a clutch hub which has a cylindrical member located in the clutch drum and is disposed at the same axis line as the shaft; and
a plurality of inner plates which are slidably splined to an outer circumferential surface of the cylindrical member of the clutch hub,
in which the cylindrical member is divided into a plurality of areas having identical length in the circumferential direction thereof, each of the areas is provided with a group of lubricating gallery set consisting of a plurality of lubricating galleries formed at mutually different positions in the axial direction with the positions of the plurality of lubricating galleries which constitute the group of lubricating gallery set shifted in the circumferential direction, and lubricating oil is supplied to the cylindrical member by flowing from the inner circumferential surface to the outer circumferential surface via the plurality of lubricating galleries,
wherein an open end portion of the cylindrical member is provided with a circular dam portion protruding inward in a radial direction, an inner radius of the dam portion is configured to be not greater than a radius of a concentric circle which is concentric with the cylindrical member and is tangent to a line joining two ends of each of the areas on the inner circumferential surface of the cylindrical member in the circumferential direction.
